(19) United States
(12) Patent Application Publication
(10) Pub. No.: US 2014/0279005 A1
(43) Pub. Date: Sep. 18, 2014

(54) SYSTEMS AND METHODS FOR PROVIDING AN OFFER BASED ON AN ACCOUNT BALANCE AND LOCATION OF A CONSUMER

(71) Applicant: BANK OF AMERICA CORPORATION, Charlotte, NC (US)

(72) Inventors: Matthew A. Calman, Charlotte, NC (US); Susan Smith Thomas, Gastonia, NC (US); Laura Corinne Bondesen, Charlotte, NC (US); David M. Grigg, Rock Hill, SC (US)

(73) Assignee: BANK OF AMERICA CORPORATION, Charlotte, NC (US)

(21) Appl. No.: 13/827,664

(22) Filed: Mar. 14, 2013

(51) Int. Cl. G06Q 30/02

(52) U.S. Cl. CPC G06Q 30/0215
USPC 705/14.58

(57) ABSTRACT

Embodiments of the present invention relate to systems, methods, and computer program products for presenting an offer to a consumer based on account balance information and consumer location information. In some embodiments, a method is provided that includes: (a) receive geographic location information associated with the mobile computing device of the consumer; (b) receive information associated with the credit account of the consumer, wherein the consumer is a holder of the credit account; (c) determine whether the balance value of the credit account has an existing balance value greater than zero; and (d) present, via the mobile computing device of the consumer, the offer to the consumer based at least in part on determining that the geographic location of the mobile device of the consumer is proximate to or coincident with a location of the merchant and determining that the existing balance value of the credit account associated with the merchant is greater than zero.

### BACKGROUND

Consumers often have one or more financial accounts, such as various credit card accounts, retail credit account, prepaid accounts, or similar revolving credit accounts. In many instances, consumers will maintain some balance amount on the credit account for purchases made using the credit account. Oftentimes, consumers will also frequent or visit a merchant store that is somehow associated or affiliated with the credit account having the balance. In such an instance, it may present an opportunity to the credit account issuer, prepaid account issuer, or merchant to incentivize the consumer to reduce or pay down the balance on the credit account. In other instances, an opportunity to incentive the prepaid account holder to increase the available funds in the account to be used for additional or future purchases.

However, there is currently not efficient and reliable means for providing an offer for incentivizing a consumer having a credit account with a balance to apply a payment to the credit account for reducing or eliminating the balance. Nor is there an efficient and reliable means for providing an offer for incentivizing a consumer having a prepaid account to increase the available funds in the account. As such, there is a need to provide a means for incentivizing consumers to pay an amount towards existing balances on a credit account and for adding additional funds to a prepaid account.

### BRIEF SUMMARY

### Brief Overview

The following presents a simplified summary of one or more embodiments of the invention in order to provide a basic understanding of such embodiments. This summary is not an extensive overview of all contemplated embodiments and is not intended to identify key or critical elements of all embodiments or delineate the scope of any or all embodiments. Its sole purpose is to present some concepts of one or more embodiments in a simplified form as a prelude to the more detailed description that is presented later.

### Brief Summary of Providing Offers Based on Account Balances and Consumer Location

Some embodiments of the present invention provide a system that includes: a mobile computing device including a processor and a memory; a software module stored in the memory, comprising executable instructions that when executed by the computer processing device causes the processing device to: (a) receive geographic location information associated with the mobile computing device of the consumer; (b) receive information associated with the credit account of the consumer, wherein the consumer is a holder of the credit account; (c) determine whether the balance value of the credit account has an existing balance value greater than zero; and (d) present, via the mobile computing device of the consumer, the offer to the consumer based at least in part on determining that the geographic location of the mobile device of the consumer is proximate to or coincident with a location of the merchant and determining that the existing balance value of the credit account associated with the merchant is greater than zero.

In some embodiments of the system, the received information associated with the credit account comprises a balance value of the credit account of the consumer.

In some embodiments of the system, the processing device is further configured to identify one or more merchants that are associated with the credit account of the consumer and that are within a predetermined distance of the mobile device of the consumer.

In some embodiments of the system, the processing device is further configured to determine the offer for the consumer based at least partially on the balance value of the credit account.

In some embodiments of the system, the processing device is further configured to: (a) send a notification to the identified merchant, the notification comprising information indicating that the consumer is at or near the identified merchant and further indicating that the consumer has the credit account with the existing balance greater than zero; and (b) allow the identified merchant to send, in real-time or substantially real-time, the offer to the mobile device associated with the consumer and while the consumer is at or near the identified merchant.

In some embodiments of the system, the credit account is issued by the merchant or in partnership with the merchant, and the credit account is specifically designated for use by the consumer at locations of the merchant and/or online websites associated with the merchant.

In some embodiments of the system, the processing device is further configured to present via the mobile device of the consumer a plurality of offers based at least in part on the balance value of the credit account and the location of the consumer.

In one aspect of the invention, a computer-implemented method is provided for presenting an offer based on a location of a consumer having a credit account associated with a merchant. The computer-implemented method includes using a computer processor to execute computer program code instructions stored in one or more non-transitory computer-readable mediums, wherein said computer program code instructions are structured to cause said computer processor to: (a) receive geographic location information associated with the mobile computing device of the consumer; (b) receive information associated with the credit account of the consumer, wherein the consumer is a holder of the credit account; (c) determine whether the balance value of the credit account has an existing balance value greater than zero; and (d) present, via the mobile computing device of the consumer, the offer to the consumer based at least in part on determining that the geographic location of the mobile device of the consumer is proximate to or coincident with a location of the merchant and determining that the existing balance value of the credit account associated with the merchant is greater than zero.

In some embodiments of the computer-implemented method, the received information associated with the credit account comprises a balance value of the credit account of the consumer.

In some embodiments of the computer-implemented method, the processing device is further configured to identify one or more merchants that are associated with the credit account of the consumer and that are within a predetermined distance of the mobile device of the consumer.

In some embodiments of the computer-implemented method, the processing device is further configured to determine the offer for the consumer based at least partially on the balance value of the credit account.

In some embodiments of the computer-implemented method, the processing device is further configured to: (a) send a notification to the identified merchant, the notification comprising information indicating that the consumer is at or near the identified merchant and further indicating that the consumer has the credit account with the existing balance greater than zero; and (b) allow the identified merchant to send, in real-time or substantially real-time, the offer to the mobile device associated with the consumer and while the consumer is at or near the identified merchant.

In some embodiments of the computer-implemented method, the credit account is issued by the merchant or in partnership with the merchant, and the credit account is specifically designated for use by the consumer at locations of the merchant and/or online websites associated with the merchant.

In some embodiments of the computer-implemented method, the processing device is further configured to present via the mobile device of the consumer a plurality of offers based at least in part on the balance value of the credit account and the location of the consumer.

In another aspect, a computer program product for providing information related to a goal of a user is provided that includes a non-transitory computer-readable medium, wherein the non-transitory computer-readable medium comprises one or more computer-executable program code portions that, when executed by a computer, cause the computer to: (a) receive geographic location information associated with the mobile computing device of the consumer; (b) receive information associated with the credit account of the consumer, wherein the consumer is a holder of the credit account; (c) determine whether the balance value of the credit account has an existing balance value greater than zero; and (d) present, via the mobile computing device of the consumer, the offer to the consumer based at least in part on determining that the geographic location of the mobile device of the consumer is proximate to or coincident with a location of the merchant and determining that the existing balance value of the credit account associated with the merchant is greater than zero.

In some embodiments of the computer program product, the received information associated with the credit account comprises a balance value of the credit account of the consumer.

In some embodiments of the computer program product, the one or more computer-executable program code portions, when executed by the computer, causes the computer to identify one or more merchants that are associated with the credit account of the consumer and that are within a predetermined distance of the mobile device of the consumer.

In some embodiments of the computer program product, the one or more computer-executable program code portions, when executed by the computer, causes the computer to determine the offer for the consumer based at least partially on the balance value of the credit account.

In some embodiments of the computer program product, the one or more computer-executable program code portions, when executed by the computer, cause the computer to: (a) send a notification to the identified merchant, the notification comprising information indicating that the consumer is at or near the identified merchant and further indicating that the consumer has the credit account with the existing balance greater than zero; and (b) allow the identified merchant to send, in real-time or substantially real-time, the offer to the mobile device associated with the consumer and while the consumer is at or near the identified merchant.

In some embodiments of the computer program product, the credit account is issued by the merchant or in partnership with the merchant, and the credit account is specifically designated for use by the consumer at locations of the merchant and/or online websites associated with the merchant.

In some embodiments of the computer program product, the one or more computer-executable program code portions, when executed by the computer, cause the computer to present via the mobile device of the consumer a plurality of offers based at least in part on the balance value of the credit account and the location of the consumer.

### Brief Summary of Determining Offers Based on Account Balances and Consumer Location

Some embodiments of the present invention provide a system that includes: a mobile computing device including a processor and a memory; a software module stored in the memory, comprising executable instructions that when executed by the computer processing device causes the processing device to: (a) receive geographic location information associated with a mobile computing device of the consumer; (b) receive information associated with the credit account of the consumer, wherein the consumer is a holder of the credit account; (c) determine a balance value of the credit account of the consumer; and (d) determine an offer to present to the consumer based at least partially on the balance value of the credit account and a determined location of the consumer.

In some embodiments of the system, determining the offer further comprises: (a) comparing the balance value of the credit account to tiered thresholds, wherein each of the tiers of the tiered thresholds comprises a range of credit account balance values, wherein each range of credit account balance values corresponds to an offer, and wherein each of the ranges are non-overlapping; and (b) determining that the balance value of the credit account falls within at least one of the range of credit account balance values.

In some embodiments of the system, the processing device is further configured to: (a) receive information relating to a payment made to the credit account of the consumer, wherein the payment comprises a payment value; and (b) wherein determining the offer to present to the consumer is further based at least partially on the payment value of the payment made to the credit account.

In some embodiments of the system, the processing device is further configured to: (a) present a plurality of options to the consumer for determining the offer, where each of the plurality of options comprises an offer with a corresponding suggested payment amount to be made by the consumer towards the balance value of the credit account; (b) receive a selection of at least one of the plurality of options; and (c) wherein determining the offer to present to the consumer is further based at least partially on the selection of the at least one of the plurality of options.

In some embodiments of the system, the offer presented to the consumer is for a discount off of a purchase being made by the consumer or off of the balance value of the credit account.

In some embodiments of the system, the offer presented to the consumer is activated once the consumer makes a payment in the account, such that the balance value of the credit account is reduced or eliminated.

In some embodiments of the system, wherein the offer presented to the consumer is dynamically determined and is further based on a value of a purchase being made by the consumer using the credit account.

In one aspect of the invention, a computer-implemented method is provided for presenting an offer based on a location of a consumer having a credit account associated with a merchant. The computer-implemented method includes using a computer processor to execute computer program code instructions stored in one or more non-transitory computer-readable mediums, wherein said computer program code instructions are structured to cause said computer processor to: (a) receive geographic location information associated with a mobile computing device of the consumer; (b) receive information associated with the credit account of the consumer, wherein the consumer is a holder of the credit account; (c) determine a balance value of the credit account of the consumer; and (d) determine an offer to present to the consumer based at least partially on the balance value of the credit account and a determined location of the consumer.

In some embodiments of the computer-implemented method, determining the offer further comprises: (a) comparing the balance value of the credit account to tiered thresholds, wherein each of the tiers of the tiered thresholds comprises a range of credit account balance values, wherein each range of credit account balance values corresponds to an offer, and wherein each of the ranges are non-overlapping; and (b) determining that the balance value of the credit account falls within at least one of the range of credit account balance values.

In some embodiments of the computer-implemented method, the processing device is further configured to: (a) receive information relating to a payment made to the credit account of the consumer, wherein the payment comprises a payment value; and (b) wherein determining the offer to present to the consumer is further based at least partially on the payment value of the payment made to the credit account.

In some embodiments of the computer-implemented method, the processing device is further configured to: (a) present a plurality of options to the consumer for determining the offer, where each of the plurality of options comprises an offer with a corresponding suggested payment amount to be made by the consumer towards the balance value of the credit account; (b) receive a selection of at least one of the plurality of options; and (c) wherein determining the offer to present to the consumer is further based at least partially on the selection of the at least one of the plurality of options.

In some embodiments of the computer-implemented method, the offer presented to the consumer is for a discount off of a purchase being made by the consumer or off of the balance value of the credit account.

In some embodiments of the computer-implemented method, the offer presented to the consumer is activated once the consumer makes a payment in the account, such that the balance value of the credit account is reduced or eliminated.

In some embodiments of the computer-implemented method, wherein the offer presented to the consumer is dynamically determined and is further based on a value of a purchase being made by the consumer using the credit account.

In another aspect, a computer program product for providing information related to a goal of a user is provided that includes a non-transitory computer-readable medium, wherein the non-transitory computer-readable medium comprises one or more computer-executable program code portions that, when executed by a computer, cause the computer to: (a) receive geographic location information associated with a mobile computing device of the consumer; (b) receive information associated with the credit account of the consumer, wherein the consumer is a holder of the credit account; (c) determine a balance value of the credit account of the consumer; and (d) determine an offer to present to the consumer based at least partially on the balance value of the credit account and a determined location of the consumer.

In some embodiments of the computer program product, determining the offer further comprises: (a) comparing the balance value of the credit account to tiered thresholds, wherein each of the tiers of the tiered thresholds comprises a range of credit account balance values, wherein each range of credit account balance values corresponds to an offer, and wherein each of the ranges are non-overlapping; and (b) determining that the balance value of the credit account falls within at least one of the range of credit account balance values.

In some embodiments of the computer program product, the one or more computer-executable program code portions, when executed by the computer, causes the computer to: (a) receive information relating to a payment made to the credit account of the consumer, wherein the payment comprises a payment value; and (b) wherein determining the offer to present to the consumer is further based at least partially on the payment value of the payment made to the credit account.

In some embodiments of the computer program product, the one or more computer-executable program code portions, when executed by the computer, causes the computer to: (a) present a plurality of options to the consumer for determining the offer, where each of the plurality of options comprises an offer with a corresponding suggested payment amount to be made by the consumer towards the balance value of the credit account; (b) receive a selection of at least one of the plurality of options; and (c) wherein determining the offer to present to the consumer is further based at least partially on the selection of the at least one of the plurality of options.

In some embodiments of the computer program product, the offer presented to the consumer is for a discount off of a purchase being made by the consumer or off of the balance value of the credit account.

In some embodiments of the computer program product, the offer presented to the consumer is activated once the consumer makes a payment in the account, such that the balance value of the credit account is reduced or eliminated.

In some embodiments of the computer program product, the offer presented to the consumer is dynamically determined and is further based on a value of a purchase being made by the consumer using the credit account.

### Brief Summary of Determining an Offer Based on a Prepaid Account Balance & Geo-Location

Some embodiments of the present invention provide a system that includes: a mobile computing device including a processor and a memory; a software module stored in the memory, comprising executable instructions that when executed by the computer processing device causes the processing device to: (a) receive geographic location information associated the consumer; (b) receive information associated with the prepaid account of the consumer, wherein the consumer is a holder of the prepaid account; (c) determine a balance value of the prepaid account; and (d) present the offer to the consumer based at least in part on determining the balance of the prepaid account and the location of the consumer.

In some embodiments of the system, wherein the received information associated with the prepaid account comprises a substantially real-time balance value of the prepaid account of the consumer.

In some embodiments of the system, the processing device is further configured to: (a) compare the balance value of the prepaid account to tiered thresholds, wherein each of the tiers of the tiered thresholds comprises a range of prepaid account balance values, wherein each range of prepaid account balance values corresponds to an offer, and wherein each of the ranges are non-overlapping; and (b) determine that the balance value of the prepaid account falls within at least one of the range of prepaid account balance values.

In some embodiments of the system, the processing device is further configured to: (a) present a plurality of options to the consumer for determining the offer, where each of the plurality of options comprises an offer with a corresponding suggested deposit amount to be made by the consumer towards the balance value of the prepaid account; (b) receive a selection of at least one of the plurality of options; and (c) wherein determining the offer to present to the consumer is further based at least partially on the selection of the at least one of the plurality of options.

In some embodiments of the system, the processing device is further configured to: (a) send a notification to the identified merchant, the notification comprising information indicating that the consumer is at or near the identified merchant and further indicating that the consumer has the prepaid account with a diminished balance; and (b) allow the identified merchant to send, in real-time or substantially real-time, the offer to the mobile device associated with the consumer and while the consumer is at or near the identified merchant.

In some embodiments of the system, wherein the offer presented to the consumer is for a discount off of a current, prior, or future purchase.

In some embodiments of the system, the processing device is further configured to (a) receive information relating to a deposit made to the prepaid account of the consumer, wherein the payment comprises a deposit value; and (b) wherein determining the offer to present to the consumer is further based at least partially on the deposit value of the payment made to the prepaid account.

In one aspect of the invention, a computer-implemented method is provided for presenting an offer based on a location of a consumer having a credit account associated with a merchant. The computer-implemented method includes using a computer processor to execute computer program code instructions stored in one or more non-transitory computer-readable mediums, wherein said computer program code instructions are structured to cause said computer processor to: (a) receive geographic location information associated the consumer; (b) receive information associated with the prepaid account of the consumer, wherein the consumer is a holder of the prepaid account; (c) determine a balance value of the prepaid account; and (d) present the offer to the consumer based at least in part on determining the balance of the prepaid account and the location of the consumer.

In some embodiments of the computer-implemented method, wherein the received information associated with the prepaid account comprises a substantially real-time balance value of the prepaid account of the consumer.

In some embodiments of the computer-implemented method, the processing device is further configured to: (a) compare the balance value of the prepaid account to tiered thresholds, wherein each of the tiers of the tiered thresholds comprises a range of prepaid account balance values, wherein each range of prepaid account balance values corresponds to an offer, and wherein each of the ranges are non-overlapping; and (b) determine that the balance value of the prepaid account falls within at least one of the range of prepaid account balance values.

In some embodiments of the computer-implemented method, the processing device is further configured to: (a) present a plurality of options to the consumer for determining the offer, where each of the plurality of options comprises an offer with a corresponding suggested deposit amount to be made by the consumer towards the balance value of the prepaid account; (b) receive a selection of at least one of the plurality of options; and (c) wherein determining the offer to present to the consumer is further based at least partially on the selection of the at least one of the plurality of options.

In some embodiments of the computer-implemented method, the processing device is further configured to: (a) send a notification to the identified merchant, the notification comprising information indicating that the consumer is at or near the identified merchant and further indicating that the consumer has the prepaid account with a diminished balance; and (b) allow the identified merchant to send, in real-time or substantially real-time, the offer to the mobile device associated with the consumer and while the consumer is at or near the identified merchant.

In some embodiments of the computer-implemented method, wherein the offer presented to the consumer is for a discount off of a current, prior, or future purchase.

In some embodiments of the computer-implemented method, the processing device is further configured to (a) receive information relating to a deposit made to the prepaid account of the consumer, wherein the payment comprises a deposit value; and (b) wherein determining the offer to present to the consumer is further based at least partially on the deposit value of the payment made to the prepaid account.

In another aspect, a computer program product for providing information related to a goal of a user is provided that includes a non-transitory computer-readable medium, wherein the non-transitory computer-readable medium comprises one or more computer-executable program code portions that, when executed by a computer, cause the computer to: (a) receive geographic location information associated the consumer; (b) receive information associated with the prepaid account of the consumer, wherein the consumer is a holder of the prepaid account; (c) determine a balance value of the prepaid account; and (d) present the offer to the consumer based at least in part on determining the balance of the prepaid account and the location of the consumer.

In some embodiments of the computer program product, wherein the received information associated with the prepaid account comprises a substantially real-time balance value of the prepaid account of the consumer.

In some embodiments of the computer program product, the one or more computer-executable program code portions, when executed by the computer, causes the computer to: (a) compare the balance value of the prepaid account to tiered thresholds, wherein each of the tiers of the tiered thresholds comprises a range of prepaid account balance values, wherein each range of prepaid account balance values corresponds to an offer, and wherein each of the ranges are non-overlapping; and (b) determine that the balance value of the prepaid account falls within at least one of the range of prepaid account balance values.

In some embodiments of the computer program product, the one or more computer-executable program code portions, when executed by the computer, causes the computer to: (a) present a plurality of options to the consumer for determining the offer, where each of the plurality of options comprises an offer with a corresponding suggested deposit amount to be made by the consumer towards the balance value of the prepaid account; (b) receive a selection of at least one of the plurality of options; and (c) wherein determining the offer to present to the consumer is further based at least partially on the selection of the at least one of the plurality of options.

In some embodiments of the computer program product, the one or more computer-executable program code portions, when executed by the computer, cause the computer to: (a) send a notification to the identified merchant, the notification comprising information indicating that the consumer is at or near the identified merchant and further indicating that the consumer has the prepaid account with a diminished balance; and (b) allow the identified merchant to send, in real-time or substantially real-time, the offer to the mobile device associated with the consumer and while the consumer is at or near the identified merchant.

In some embodiments of the computer program product, wherein the offer presented to the consumer is for a discount off of a current, prior, or future purchase.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a block diagram illustrating an environment for presenting an offer based on account balance and consumer location, in accordance with an embodiment of the invention;

FIG. 2 provides a block diagram illustrating the mobile computing device of a consumer of FIG. 1 in more detail, in accordance with an embodiment of the invention;

FIG. 3 provides a block diagram illustrating the financial management system of FIG. 1 in more detail, in accordance with an embodiment of the invention;

FIG. 4 provides a block diagram illustrating the merchant system of FIG. 1 in more detail, in accordance with an embodiment of the invention;

FIG. 5 provides a block diagram illustrating the credit account balance communication system of FIG. 1 in more detail, in accordance with an embodiment of the invention;

FIG. 6 provides a flow chart illustrating presenting an offer based on account balance and consumer location, in accordance with some embodiments of the present invention;

FIG. 7 provides a flow chart illustrating determining an offer based on an account balance and consumer location, in accordance with some embodiments of the present invention.

FIG. 8 provides a flow chart illustrating determining an offer based on a prepaid account balance and consumer location, in accordance with some embodiments of the present invention.

### DETAILED DESCRIPTION OF EMBODIMENTS OF THE INVENTION

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout. Additionally, while embodiments are disclosed as “comprising” elements, it should be understood that the embodiments may also “consist of” elements or “consist essentially of” elements.

In accordance with embodiments of the invention, the terms “financial institution” or “financial entity” include any organization that processes financial transactions including, but not limited to, banks, credit unions, savings and loan associations, investment companies, stock brokerages, asset management firms, insurance companies and the like. As used herein, the term “user” includes a customer of a financial institution, a financial account holder, an agent of an account holder, a user associated with a payment device, a merchant, an employee of a merchant, a business or non-profit entity, and the like. The term “merchant” may mean a brick and mortar merchant, an internet retailer a service provider, a mobile merchant, or the like, and thus a point of sale for a transaction may instead by a time of sale for the transaction.

As used herein, the term “products” refers to goods, services, and/or the like. As used herein, the term “merchant” refers to any entity involved in advertising, promoting, offering, creating, manufacturing, selling, or otherwise providing one or more products to one or more consumers. For example, the merchant may be a manufacturer, retailer, wholesaler, advertiser, marketer, distributor, and/or the like.

As used herein, the terms “prepaid account” refers to a deposit account that is associated with a prepaid card, mobile payment device, in-store managed account, or electronic payment device that can be loaded and/or reloaded with funds. In some embodiments, the holder of the prepaid account can exceed the available funds or credit in the account and in other embodiments, the holder of the prepaid account cannot exceed the available funds in the prepaid account. In some embodiments, the prepaid card account may be used to engage in one or more transactions but only if those one or more transactions are “paid for” in advance. Additionally or alternatively, in some embodiments, the prepaid card account is not a conventional checking account, savings account, credit card account, or the like. Further, in some embodiments, the prepaid card account is not linked or otherwise tied to a deposit account, credit account, master account, or sub-account. This is not to say, however, that the prepaid card account cannot be loaded and/or reloaded with funds from one or more deposit and/or credit accounts. For example, in some embodiments, the holder of the prepaid card account may use the holder's checking account to load the prepaid card account with funds; however, if the prepaid card account attempts to engage in a transaction exceeding the available funds in the prepaid card account, the checking account cannot be used to cover the amount exceeding the available balance of the prepaid account. In some embodiments, the prepaid account is issued by a merchant and/or an affiliate of the merchant in which case, the prepaid account is determined to be a merchant-specific merchant account that, in most instances, can only be used to purchase goods and/or services from the merchant. The prepaid account may be used to purchase goods and/or services at merchant locations or at an online site with merchant goods and/or services or at an online webpage associated with a merchant.

As used herein, the terms “credit account” refer to a non-deposit account that is associated with a credit card, mobile payment device, online account, or electronic payment device that extends credit to the consumer. The credit extended to the consumer may be used to engage in one or more transactions without expending the money of the consumer or to make various purchases of goods and/or services. In some embodiments, the credit account has a credit limit which the user cannot exceed, but in some instances, the issuer of the credit account allows the user to exceed the available credit or credit limit of the credit account when making a purchase.

Methods, systems, apparatuses, and computer program products are described herein for communicating an offer to a consumer having a credit account with a balance upon determining the geo-location of the consumer. In some manner, a merchant or credit account issuer associated with the credit account of the consumer may determine that the geo-location of the consumer is proximate to or coincident with the geo-location of an associated merchant store or location. A merchant or credit account issuer can use positioning data, such as global positioning satellite data, mobile device data, social networking data, Internet search data, and the like to determine the consumer's current and recent locations. This will enable a merchant or credit card issuer to communicate an offer to the consumer when the consumer is close enough to the merchant to make a payment in a store location or while the consumer is shopping at the merchant store location and is immediately available to take advantage of the benefit provided by the offer. Contemporaneously with determining the geo-location of the consumer or after determining the geo-location of the consumer, the merchant or credit account issuer may determine whether the credit account associated with the consumer has a balance and is therefore eligible to receive an offer or incentive for paying down the balance of the credit account. For example, a consumer may have a retail merchant credit account issued by Beta Example Merchant (“BEM”), where the retail merchant credit account has a balance of $100.00. In such an example, if the customer enters or is close to a store location of BEM, the system may provide an offer to a mobile device of the customer, where the offer may be a 10% off of a current purchase when the customer pays down the existing balance on the retail credit account today.

FIG. 1 provides a block diagram illustrating a mobile commerce system and environment 100 in accordance with an embodiment of the invention. As illustrated, the system 100 generally includes a consumer 110, a network 120, a positioning system 150, a consumer mobile device 200, a financial management system 300, a merchant system 400, and a credit account balance communication system 500. The consumer 110 may be any individual or entity having a credit account issued by the merchant or an affiliate of the merchant, where the credit account has a balance value greater than zero.

The consumer 110 has a mobile device 200, such as a mobile phone, personal digital assistant (PDA), personal navigation device, personal web-surfing device, or other personal/mobile computing device. Embodiments of the consumer mobile device 200 are described in greater detail in FIG. 2 and the accompanying description.

The network 120 may be any of one or more devices or connections communicably coupling two or more devices. For example, the network 120 may include a global area network, such as the Internet, a wide area network, a local area network, a wireless network, a wire-line network, one or more modems, one or more servers, one or more relay devices, one or more direct electrical connections, one or more satellites, and/or the like, or a combination thereof. As illustrated, in some embodiments, the network 120 includes a wireless telephone network 122, such as a cellular network or other mobile telephone/data network known in the art. As also illustrated, in some embodiments, the network 120 includes a payment network 124 for processing electronic or other payments and transferring money between banks and other entities. For example, the payment network 124 may include the networks of one or more banks or other well-known payment network and/or the like.

According to various embodiments, the positioning system 150 may be the Global Positioning System (GPS) or other systems for identifying precise geographical locations of individuals or devices or positions of individuals or devices relative to known objects or locations. For example, some embodiments of the invention include a positioning system that can identify the current latitude and longitude, and in some cases altitude, of the consumer's mobile device 200 using a sensor/transceiver in the consumer's mobile device 200 in conjunction with a satellite system and/or the wireless telephone network 122. In other embodiments, more local sensors/transceivers interact with sensors/transceivers of the consumer's mobile device 200 to determine if the consumer 110 is within a certain distance from a merchant and/or moving toward or away from the merchant. For example, in one embodiment of the invention, a merchant has sensors at its entrances that can communicate with consumer mobile devices 200 that have near field communication (NFC) capabilities and, thereby, determine when the consumer 110 possessing the consumer mobile device 200 enters or leaves the merchant's facility.

The financial management system 300 stores financial information for the consumer 110 and/or the merchant, including account information for one or more credit account credit accounts of the consumer 110. Embodiments of the financial management system 300 and credit account information are described in greater detail in FIG. 3 and the accompanying description.

According to various embodiments, the merchant system 400 communicates offers to the consumer 110 and allows the merchant to interact with the credit account communication system 500. The merchant system 400 may also store account balance information (e.g., amount of credit used or amount of credit available on the account credit account). Embodiments of the merchant system 400 are described in greater detail in FIG. 4 and the accompanying description.

According to various embodiments, the account balance communication system 500 provides relevant credit account balance information, merchant deals or offers, and/or merchant locations that offer products or services associated with the credit account of the consumer to the mobile device 200 when the consumer 110 is near or entering the merchant's facility. Embodiments of the various processes, features, and functions managed by the account balance communication system 500 are described below in FIGS. 6 through 8 and the accompanying descriptions. Embodiments of the account balance communication system 500 are also described in greater detail in FIG. 5 and the accompanying description.

For example, as described in greater detail below, in one embodiment of the system 100, a consumer's location relative to one or more merchants is tracked using the positioning system 150 and the consumer's mobile device 200. The account balance communication system 500 and/or the merchant system 400 receives the position of the consumer's mobile device from the positioning system 150, identifies the merchant(s) or the type(s) of merchant(s) located near the consumer's mobile device 200, retrieves credit account balance information related to each merchant or type of merchant for which the consumer has or maintains a credit account and communicates an offer to the consumer's mobile device 200 for display thereon when the system determines that the consumer has a credit account with a merchant that is located at or near the consumer and when credit account has a balance that has not yet been paid by the consumer. In addition, according to one embodiment, the account balance communication system 500 and/or the financial management system 300 determines trends in the consumer's shopping behavior based on information stored by the financial management system 300, and these trends are used to determine which of two or more merchants the consumer is more likely to be visiting at a particular time of the day, when, for example, there are two or more merchants located near the consumer's mobile device 200.

FIG. 2 provides a block diagram illustrating the consumer mobile device 200 of FIG. 1 in more detail in accordance with an embodiment of the invention. In one embodiment of the invention, the mobile device 200 is a mobile telephone. However, it should be understood that a mobile telephone is merely illustrative of one type of mobile device 200 that may benefit from, employ, or otherwise be involved with embodiments of the present invention and, therefore, should not be taken to limit the scope of embodiments of the present invention. Other types of mobile devices 200 may include portable digital assistants (PDAs), pagers, mobile televisions, gaming devices, laptop computers, cameras, video recorders, audio/video player, radio, GPS devices, watches (e.g., a wrist watch), glasses (e.g., eye glasses), or any combination of the aforementioned.

The mobile device 200 generally includes a processor 210 communicably coupled to such devices as a memory 220, user output devices 236, user input devices 240, a network interface 260, a power source 215, a clock or other timer 250, a camera 280, and a positioning system device 275. The processor 210 and other processors described herein, generally include circuitry for implementing communication and/or logic functions of the mobile device 200. For example, the processor 210 may include a digital signal processor device, a microprocessor device, and various analog to digital converters, digital to analog converters, and/or other support circuits. Control and signal processing functions of the mobile device 200 are allocated between these devices according to their respective capabilities. The processor 210 thus may also include the functionality to encode and interleave messages and data prior to modulation and transmission. The processor 210 can additionally include an internal data modem. Further, the processor 210 may include functionality to operate one or more software programs, which may be stored in the memory 220. For example, the processor 210 may be capable of operating a connectivity program, such as a web browser application 222. The web browser application 222 may then allow the mobile device 200 to transmit and receive web content, such as, for example, location-based content and/or other web page content, according to a Wireless Application Protocol (WAP), Hypertext Transfer Protocol (HTTP), and/or the like. Web browser application 222 may be a continuously running application or an application that is activated by the user at any time. In some embodiments, web browser application 222 maybe in communication and/or in some manner linked to each account or credit account of the consumer. In the same embodiment, web browser application may be continuously operating and tracking the present location of the mobile device and/or consumer associated therewith, such that upon determining that the consumer is in proximity to or at a merchant location associated with a linked credit account, web browser application 222 may automatically (without human intervention) send a notification or communication to the merchant system 400, the account balance communication system 300, or financial management system 500 so that one or more of the systems can initiate an offer to the consumer when or if it determined that a linked credit has an unpaid or existing balance thereon.

The processor 210 is configured to use the network interface 260 to communicate with one or more other devices on the network 120. In this regard, the network interface 260 includes an antenna 276 operatively coupled to a transmitter 274 and a receiver 272 (together a “transceiver”). The processor 210 is configured to provide signals to and receive signals from the transmitter 274 and receiver 272, respectively. The signals may include signaling information in accordance with the air interface standard of the applicable cellular system of the wireless telephone network 122. In this regard, the mobile device 200 may be configured to operate with one or more air interface standards, communication protocols, modulation types, and access types. By way of illustration, the mobile device 200 may be configured to operate in accordance with any of a number of first, second, third, and/or fourth-generation communication protocols and/or the like. For example, the mobile device 200 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The mobile device 200 may also be configured to operate in accordance with non-cellular communication mechanisms, such as via a wireless local area network (WLAN) or other communication/data networks.

The network interface 260 may also include a payment network interface 270. The payment network interface 270 may include software, such as encryption software, and hardware, such as a modem, for communicating information to and/or from one or more devices on the payment network 124. For example, the mobile device 200 may be configured so that it can be used as a credit or debit card by, for example, wirelessly communicating account numbers or other authentication information to a POS terminal of the payment network 124 and/or merchant system 400.

As described above, the mobile device 200 has a user interface that is, like other user interfaces described herein, made up of user output devices 236 and/or user input devices 240. The user output devices 236 include a display 330 (e.g., a liquid crystal display or the like) and a speaker 232 or other audio device, which are operatively coupled to the processor 210. The user input devices 240, which allow the mobile device 200 to receive data from a user such as the consumer 110, may include any of a number of devices allowing the mobile device 200 to receive data from the user, such as a keypad, keyboard, touch-screen, touchpad, microphone, mouse, joystick, other pointer device, button, soft key, and/or other input device(s). The user interface may also include a camera 280, such as a digital camera.

The mobile device 200 also includes a positioning system device 275 that is configured to be used by the positioning system 150 to determine a location of the mobile device 200. For example, the positioning system device 275 may include a GPS transceiver. In some embodiments, the positioning system device 275 is at least partially made up of the antenna 276, transmitter 274, and receiver 272 described above. For example, in one embodiment, triangulation of cellular signals may be used to identify the approximate location of the mobile device 200. In other embodiments, the positioning system device 275 includes a proximity sensor or transmitter, such as an RFID tag, that can sense or be sensed by devices known to be located proximate a merchant or other location to determine that the consumer mobile device 200 is located proximate these known devices.

The mobile device 200 further includes a power source 215, such as a battery, for powering various circuits and other devices that are used to operate the mobile device 200. Embodiments of the mobile device 200 may also include a clock or other timer 500 configured to determine and, in some cases, communicate actual or relative time to the processor 210 or one or more other devices.

The mobile device 200 also includes a memory 220 operatively coupled to the processor 210. As used herein, memory includes any computer readable medium (as defined herein below) configured to store data, code, or other information. The memory 220 may include volatile memory, such as volatile Random Access Memory (RAM) including a cache area for the temporary storage of data. The memory 220 may also include non-volatile memory, which can be embedded and/or may be removable. The non-volatile memory can additionally or alternatively include an electrically erasable programmable read-only memory (EEPROM), flash memory or the like.

The memory 220 can store any of a number of applications which comprise computer-executable instructions/code executed by the processor 210 to implement any functions of the mobile device 200 described herein and/or any other system described herein. For example, the memory 220 may include such applications as a conventional web browser application 222 and/or an account balance communication system client application 221. These applications also typically provide a graphical user interface (GUI) on the display 330 that allows the consumer 110 to communicate with the consumer mobile device 200, the account balance communication system 500, and/or other devices. In one embodiment of the invention, when the consumer 110 decides to enroll in the account balance communication program, the consumer 110 downloads the account balance communication system client application 221 from the account balance communication system 500. In other embodiments of the invention, the consumer 110 interacts with the account balance communication system 500 via the web browser application 220 in addition to, or instead of, the account balance communication system client application 221.

The memory 220 can also store any of a number of pieces of information, and data, used by the mobile device 200 and the applications and devices that make up the mobile device 200 or are in communication with the mobile device 200 to implement the functions of the mobile device 200 and/or the other systems described herein. For example, the memory 220 may include such data as user preferences information 224 or credit account balance information 226 related to one or more credit accounts of the consumer credit account.

The user preferences information 224 may include, for example, information used by the credit account balance communication system 500 to determine the identity of the user, what type of credit account information the user wants to see credit account when the user would like to receive each type of information, how the user would like to receive each type information, when the user would like for the user's location to be available to the merchant system and/or account balance communication system 500, and/or the like. The user preference information 224 may be requested, for example, by the credit account balance communication system client application 221 via the user output devices 236, and may be entered by the consumer 110 via the user input devices 240 and then stored by the processor 210 in the memory 220 and, in some cases, communicated to the credit account balance communication system 500 via the network interface 260. In some embodiments, the user preferences include a digital certificate or other file used by the credit account balance communication system 500 to identify and/or authenticate the consumer 110 associated with the mobile device 200 in a secure and/or encrypted way. Some examples of user preferences 224 are described in greater detail below with reference to the flow charts.

FIG. 3 provides a block diagram illustrating the financial management system 300 of FIG. 1 in more detail in accordance with an embodiment of the invention. The financial management system 300 generally includes a processor 310 communicably coupled to a communication interface 330 and a memory system 320. Like the processor 210 described with respect to FIG. 2, the processor 310 comprises the circuitry and logic to perform the various functions of the financial management system 300 described herein. The communication interface 330 includes a network interface 332 and a user interface 334, which may be similar to those described above with respect to FIG. 2. In one embodiment, the financial management system 300 is a computer system of a bank or other financial institution configured to process financial transactions (e.g., credit or debit card transactions and/or the like) for consumers and/or merchants having accounts with the bank or other financial institution.

According to various embodiments, the memory system 320 stores account and/or credit account data 321 related to one or more credit accounts of or being held credit account by the consumer 110 and consumer transaction data 322 related to one or more financial transactions made by the consumer 110 through the financial institution and/or using the one or more credit accounts. The credit account data 321 includes a credit account issuer, identification of a merchant associated with the credit account (if any), the available credit or available funds of the credit account, the interest rate associated with the credit account, terms and conditions of the credit account, a credit used or balance of the credit account, the interest rate of the credit account, the expiration date of the credit account, credit account notification rules associated with each credit account, according to various embodiments.

Furthermore, financial institutions have access to large amounts of consumer data because they maintain or administer their customers' various financial accounts (e.g., credit card accounts, checking accounts, savings accounts, etc.) and because they have data related to their customers' purchases. Financial institutions track and store data related to the goods or services (e.g., “products”) that customers purchase, when their customers make their purchases, where the customers make their purchases, how much the customers spend, and/or the like, both for online and offline purchases. In addition, financial institutions have direct ties with many different merchants that use the financial institutions for their own financial needs. Accordingly, financial institutions are in a unique position to track consumer transaction data for purchases made by the consumer. In various embodiments, the consumer transaction data 322 includes information about one or more consumer transactions, such as transaction amount, date/time, location, merchant, products, transaction type, payment method, and/or the like. In addition, according to some embodiments, the financial system 300 may also track spending trends of the consumer 110 at one or more merchants over a particular time period (e.g., a week, month, quarter, year, etc.).

FIG. 4 provides a block diagram illustrating the merchant system 400 of FIG. 1 in more detail in accordance with an embodiment of the invention. The merchant system 400 generally includes a processor 410 communicably coupled to a communication interface 430 and a memory system 420. Like the processor 210 described with respect to FIG. 2, the processor 410 comprises the circuitry and logic to perform the various functions of the merchant system 400 described herein. The communication interface 430 includes a network interface 432 and a user interface 434, which may be similar to those described above with respect to FIG. 2.

The memory system 420 may include a web browser application 422 and/or an account communication system client application 421 which comprise computer-executable instructions/code executed by the processor 410 to implement at least some of the functions of the merchant system 400 described herein. These applications also typically provide a graphical user interface (GUI) on the user interface 434 that allows a merchant representative to communicate with the account communication system 500 and/or other devices. In one embodiment of the invention, a merchant representative downloads the account communication system client application 421 from the account communication system 500. In other embodiments of the invention, the merchant interacts with the account communication system 500 by using the web browser application 422 to access and log into a website of the account communication system 500. The merchant may use these applications to enroll in the account communication system 500 and to communicate (or update) price information, credit account information of the consumer, deal or offer information, or the like related to the one or more accounts of the consumer associated with the account communication system 500. The memory system 420 may also include consumer transaction data 424 and/or credit account balances 423 stored therein.

In some embodiments, the financial management system 500 tracks or monitors the credit accounts of the consumer. In certain embodiments of the invention, the consumer credit account data is communicated to the merchant system 400 for providing an offer to the consumer when it is determined that the credit account have a balance so that the merchant system 400 can determine offers to present to the consumer. In some instances, this information is provided in real time or substantially real time relative to when the consumer is actually at or near the location of the merchant.

The merchant system 400 may also include, in some embodiments, one or more positioning system devices 470, such as one or more proximity sensors for sensing a consumer mobile device 200 entering or leaving the merchant's location. For example, in one embodiment of the invention, the merchant has one or more sensors/transceivers located at the entrances and exits to the merchant's location that are configured to detect when a consumer 110 going through the entrance or exit holding a mobile device 200 that is configured to communicate a consumer identifier to the sensors/transceivers. The consumer location information gathered by the positioning system devices 470 is then communicated to the account communication system 500 so that the account communication system 500 knows whether the consumer 110 is at, entering, or exiting the merchant facility. In other embodiments of the invention, the merchant may be mobile and, as such, some embodiments of the positioning devices 470 are GPS devices indicating the location of the merchant so that the account communication system 500 can determine the merchant's location relative to the location of one or more consumers and/or one or more mobile devices of the one or more consumers. It will be appreciated that, in some embodiments of the invention, the merchant system 400 does not have any positioning system devices 470 since, for example, a GPS system or a similar system not associated with the merchant system 400 may be used to determine the location of the consumer 110, while the merchant locations may already be known and stored in the memory of the account communication system 500.

FIG. 5 provides a block diagram illustrating the account balance communication system 500 of FIG. 1 in more detail in accordance with an embodiment of the invention. The account balance communication system 500 generally includes a processor 510 communicably coupled to a communication interface 530 and a memory system 520. Like the processor 210 described above with respect to FIG. 2, the processor 510 comprises the circuitry and logic to perform the various functions of the account balance communication system 500 described herein. The communication interface 530 includes a network interface 532 and a user interface 534, which may be similar to those described above with respect to FIG. 2. The memory system 520 includes an account balance communication system application 521 including computer-executable processor code that instructs the processor 510 to perform the various functions described herein as being performed by the account balance communication system 500. The memory system 520 also includes merchant and consumer location data 525, consumer transaction data 524, consumer preference data 522, and credit account data 523 stored therein.

The merchant and consumer location data 525 includes location data for each of a plurality of merchants and each of a plurality of participating consumers 110. According to various embodiments, the merchant location data may be determined by public directories containing addresses of various merchants, from the merchant system 400 for some merchants, from the positioning system 150, the financial management system 300, and/or other systems or entities that provide addresses or other location information for one or more merchants. The consumer location data is received from the positioning system 150, which as described above, determines the consumer's current location and/or travel history by tracking the position of the consumer's mobile device 200 over time.

The consumer transaction data 524 includes information about one or more consumer transactions, such as transaction amount, time, location, merchant, products, transaction type, coupons used, payment method, and/or the like. The account communication system 500 may receive the consumer transaction data 524 from the financial management system 300, the merchant system 400, the consumer mobile device 200, and/or other systems. In some embodiments of the invention, the account communication system application 521 (when executed by the processor 510) maps the consumer transaction data 524 against the merchant and consumer location data 525 by, amongst other things, correlating the time of each consumer transaction with the consumer's location at that time and by comparing the consumer's location with the locations of a plurality of merchants. In this way, spending trends are identified for each consumer 110.

The consumer preference data 522 may include, for example, information used by the account communication system 500 to determine the type(s) of credit account(s) for which the consumer 110 is a holder and the respective balances of the credit account(s), when the consumer 110 would like to receive account information, how the consumer 110 would like to receive account information, when the consumer 110 would like for the consumer's location to be tracked by the account communication system 500, the particular distance range between the consumer mobile device and the merchant location when offers should be communicated to the mobile device 200, and/or the like. The consumer preference data 522 may be, for example, consumer-generated and received from the consumer mobile device 200. The consumer preference data 522 may also be determined by the account communication system 500 automatically and/or based on trends identified in the consumer transaction data 524. Some examples of consumer preference data 522 are described in greater detail below with reference to the flow charts shown in FIG. 6.

The credit account data 523 may include, for example, for each account and/or spending account: a credit account balance amount, products and/or services that can be purchased using the credit account, a merchant or type(s) of merchant(s) associated with the credit account, merchant category code(s) associated with the credit account, an issuer of the credit account, and a credit account name. In some embodiments, at least a portion of the credit account data 523 is provided to the account communication system 500 from the financial management system 300, and in other embodiments, the credit account data 523 is provided directly to the account communication system 500. Some examples of credit account data 523 are described in greater detail below with reference to FIG. 6 through 11.

### Presenting an Offer Based on an Account Balance and Consumer Location

FIG. 6 is a flowchart providing an overview of a system and method 600 for providing an offer based on a location of a consumer having a credit account associated with a merchant, in accordance with an embodiment of the invention. It will be understood that one or more devices, such as one or more mobile devices and/or one or more other computing devices and/or servers, can be configured to perform one or more steps of the system and method 600. In some embodiments, the one or more devices performing the steps are associated with a merchant and/or financial institution. In other embodiments, the one or more devices performing the steps are associated with a business, third party, and/or user.

As represented by block 602, the system receives geographic location information associated with a mobile device of a consumer. The system may receive the geographic location information from any source including the mobile device or a system of a merchant that is in close proximity to the mobile device of the consumer. In some embodiments, the consumer may provide his geographic location information via one or more input devices on the mobile device. The geographic location information may include real-time or substantially real-time data or information relating to the physical location of the consumer. The system can use the geographic location information to determine the consumer's location relative to one or more merchant locations or stores. For example, in one embodiment of the invention, the positioning system 150 determines the location of the consumer's mobile device 200 relative to the world or other geography (e.g., via a GPS system or similar system). In another example embodiment, proximity sensors are located proximate to one or more merchants, and these sensors can determine when the consumer mobile device 200 is visiting, approaching, and/or leaving the one or more merchants. For example, participating merchants may install sensors at each entrance and exit of the merchant location and determine that a consumer 110 is visiting the merchant location by sensing the positioning system device 275 of the consumer mobile device 200 when the consumer 110 walks through an entrance with the consumer mobile device 200. In such an embodiment, the goal communication system 200 may determine that the consumer 110 is leaving the merchant location by either having dedicated exits, by determining the proximity of the consumer mobile device 200 to an exit, or by determining that the consumer 110 must be exiting if the consumer mobile device 200 is sensed in an entrance/exit after being sensed when the consumer 110 entered the merchant location. In another embodiment of the invention, the consumer mobile device 200 has a sensor configured to sense transmitters or other devices located proximate one or more merchants (e.g., at the entrances and exits of the merchant's location) and then communicates the sensed information to the account communication system 500.

Now referring to block 604, the system receives information associated with a credit account of the consumer that is issued by the merchant or issued by an affiliate of the merchant. The information associated with the credit account of the consumer can be any information related to the features of the credit account including available credit, interest rate, the issuing financial institution, expiration date, the name of the holder of the credit account, the due date for any payments for the account, a determination of whether a payment is past due, a determination of whether a payment is pending in the credit account, purchase history, and the like. The information associated with the credit account may also include the outstanding or unpaid balance of the credit account. For example, the system may receive information associated with the credit account indicating that the credit account has a credit threshold maximum of $500.00 and an outstanding balance of $100.00. The outstanding balance or balance value of $100.00 may be a balance from prior purchases made using the credit account. It will be understood that the information associated with the credit may be any information related to the credit account or usage of the credit account and is not limited to the above-described information.

In some embodiments, the system continuously or periodically monitors the information associated with the credit account of the consumer, and in particular, the balance value associated with the credit account. In this way, the system is able to determine recent or possible changes in the balance of the credit account and automatically present an offer to the consumer when the consumer is in proximity or in a location coincident with a merchant that is associated with the account. For example, in one embodiment of the invention, the system is in constant or frequent communication with the system that maintains the credit account such that the system is continuously aware of the balance value of the credit account.

As represented in block 606, the system identifies one or more merchant locations within a predetermined distance and/or distance range of the location of the mobile device or of the consumer. According to various embodiments, for example, the system compares the location of the consumer's mobile device to the known location (e.g., address) of one or more merchants. In this way, the system can determine whether a merchant associated with one or more credit accounts of the consumer is in real-time or near real-time proximity to the consumer and/or the mobile device of the consumer. In one embodiment, the system utilizes a database storing merchant locations that are within a particular distance range or within proximity of the mobile device of the consumer to identify merchants. According to some embodiments, the particular distance range is between 0 and about 200 feet, and in one embodiment, the particular distance range is between 0 and about 50 feet. In yet another embodiment, the particular distance range is less than about 50 feet. In other embodiments, the distance range may include other distances (e.g., one mile, a half mile, a quarter kilometer, etc.). The particular distance range, according to various embodiments, is set by the consumer or by the one or more systems described herein and may be stored as consumer preference data 522. Some embodiments of the system may have a distance range of zero and require that the consumer be located in the location or store of the merchant.

In some embodiments, once the system identifies a merchant and/or merchant location associated with the credit account of the consumer, the system sends a notification to the merchant. In some embodiments, the notification sent to the merchant comprises information relating to the location of the consumer and the balance of the credit account and/or other information relating to the credit account. In this way, the system allows the merchant to determine an offer for the consumer and present, via the mobile device associated with the consumer, an offer. The offer may be any type of offer which relates to, but is not limited to, discounts (e.g., $25 off, 10% off, and the like) off of purchase transaction and/or credit account balance amount, loyalty points, coupons, product or services offers, gifts, a give-away, an incentive, a credit (e.g., account credit), a financing offer, credit account interest rate reduction, payment plan, rebate, and the like.

As represented by block 608, the system determines a balance value of the credit account associated with the merchant and held by the consumer. In some embodiments, the system determines whether the credit account has a balance value greater than zero. In some embodiments, the system uses the received information associated with the credit account to determine whether the credit account of the consumer has a balance. In other embodiments, the system may receive input from the user indicating the balance value amount associated with the credit account. The credit account balance determination can be done in numerous ways and is not limited to the methods described herein. In some embodiments, the system determines the credit limit or credit maximum of the credit account and the unused credit amount or value (e.g., available credit) of the account to determine the balance value of the account. For example, when the system determines that the credit maximum for the credit account is $500.00 and the unused credit amounts of the credit account is $400. In such an example, the system subtracts the two values in order to determine that the balance of the credit account is $100.00. In some embodiments, the information associated with the credit account received by the system includes the balance amount, such that an additional determination of the balance value for the account is not required.

As represented by block 610, provides an offer to the consumer. In some embodiments, when the system determines that the geographic location of the mobile device of the consumer is proximate to and/or coincident with a location of a merchant and further determines that the credit account associated with the merchant has an existing balance value greater than zero, the system provides an offer to the consumer. In many embodiments, the offer is only triggered when all elements are met: 1) the consumer is a holder of a credit account issued by and/or specifically designated for use at one or a specified merchant, 2) the consumer or a mobile device associated with the consumer is in close proximity or at the location of the merchant, and 3) the credit account has a balance value greater than zero. Each of these elements must exist or be met contemporaneously, in most embodiments of this invention, in order for the system to provide the offer to the consumer. The offer may be triggered to the consumer automatically (without human intervention) and in real-time or substantially real-time, as the consumer is arriving or is still proximate to or coincident with the location of the merchant and/or once the elements are met. The offer may be presented to the consumer in several manners, which may include, but is not limited to, upon making the determinations, presenting the offer via the mobile device of the consumer or presenting the offer to the consumer at the point of sale or point of transaction. For example, while the consumer is shopping within a store of the merchant the system determines that the consumer has a retail credit account issued by the merchant and that the retail credit account has a balance greater than zero. In such an example, while the consumer is shopping or preparing to checkout, the system may provide a communication to the mobile device of the consumer indicating that he has received or is eligible to receive an offer. In one example, when the consumer is preparing to checkout or is in the checkout process, the system may determine that the consumer has a retail merchant card with an existing balance and cause or prompt the point of sale device (e.g., the cashier's register, self-checkout, or personnel managing the register) to notify the consumer of the offer. In yet another example, the system may determine that the user in the store of the merchant and that the retail credit card issued by the merchant has a balance, once the consumer swipes or presents the retail credit account for making a purchase. In such an example, the system provides an offer to the consumer after the consumer presents the retail credit account for purchase. The system may queue the purchase transaction of the consumer pending acceptance or decline of the offer by the consumer. The offer may also be presented to the consumer sometime after or immediately after a purchase is at the merchant associated with the retail credit account such that the consumer may still receive the benefits of the offer for the goods or services purchased that day. In another example, the system may present the offer to the consumer when the consumer is proximate to the location of the merchant but has not yet entered the merchant location. In this way, the offer may act as an incentive for the user to visit or enter the location of the merchant, pay down an existing balance value of the credit account, and also potentially make a purchase at the location of the merchant.

### Offer Determination Based on Account Balance and Consumer Location

Some embodiments of the present invention relate to system and methods for determining an offer based on a balance value of a credit account of a consumer and a location of the consumer.

Referring now to FIG. 7, a general process flow 700 is provided for determining an offer for a consumer based on a balance value of a credit account of the consumer and on a location of the consumer, in accordance with an embodiment of the present invention. The process flow 700 is similar to process flow 600 described above in relation to FIG. 6, but in process flow 700, the system analyzes the balance of the credit account, a purchase amount, products being purchased, and/or a payment amount by the consumer in determining an offer to present to the consumer. In particular, beginning with block 702, the system receives geographic location information associated with a mobile device of a consumer. Then in block 704, the system receives information associated with a credit account of the consumer that is issued by the merchant or issued by an affiliate of the merchant. At block 706, the system identifies one or more merchant locations that are proximate to or coincident with the location of the consumer. Now, at block 708, the system determines a balance value of the credit account of the consumer. As represented by block 710, the system determines an offer based at least in part on the account balance of the credit account of the consumer.

Regarding block 710, the offer may be determined statically or dynamically and based on at least one of a balance value of the credit account, a purchase amount, a payment amount to the credit account, a payment percentage amount to the credit account, any combination of the previously mentioned, and/or the like. The offer to the consumer, in some embodiments, is an offer with some benefit, where the benefit of the offer is triggered once the consumer makes a payment to the credit account. For example, in some embodiments, the system provides a static or predetermined offer to the consumer of a 10% discount off of a current, prior, or later purchase when the consumers makes a payment to the account that satisfies the entire balance of the account or results in the balance of the credit account being zero or less or substantially near zero. In a similar example, the system may provide an offer to the consumer of a 10% discount off of the existing balance on the credit account when the consumer makes a payment.

Still regarding block 710, in some embodiments, the offer benefit or amount may be any amount that is dynamically determined based on the balance of the credit account, the payment amount to the credit account, or that is predetermined based on the features and/or balance value of the credit account. The one or more features of the credit account may include the interest rate, the credit limit, where the credit account may be used, the purchases that the credit account may be used for, the ability to allow the consumer to exceed the available credit of the credit account. It will be understood that the offer amount may be determined in any manner and is not limited to the manners described herein. In some embodiments, the system determines an offer based on the features of the credit account. In some embodiments, the system determines an offer based on the balance of the credit account of the consumer. Using a tiered balance system, the system may determine certain offers that range in the benefits provided to the consumer. For example, the larger the outstanding balance on the retail credit account, the larger the offered incentive may be to the consumer. Using the tiered balance system, the opposite may also be used where the larger the outstanding balance on the retail credit account, the smaller the offered incentive may be to the consumer. The tiered balance approached for determining the offer may be embodied in several different ways. In some embodiments, the tiered balance approach includes two or more levels of balance amounts, where each of the two or more relates to or corresponds to a different offer. As an example, a first tier may include balance amounts ranging from $0.01-$50.00, a second tier may include balance amounts ranging from $50.01-$500.00, and a third tier may include balance amounts ranging from $500.01-$1000 or greater. In this example, the first tier may correspond to a discount offer of 5% off of a current or future purchase, the second tier may relate to an offer for a discount of 10% off of a current purchase, and the third tier may relate to an offer for a discount of 15% off of a current purchase. The system, if applying the tiered balance approached determines the offer to present to the consumer by comparing the balance amount of the credit account to a table or other data structure having the predetermined tiers and/or predetermined thresholds for providing a discount. Although not previously described, no offer or an offer of 0% may be presented if there is a $0 balance on the credit account.

In some embodiments, the offer amount or amount of benefit of the offer is determined based on a combination of the balance amount of the credit account and a purchase amount for a past, present, or future purchase by the consumer. In such an embodiment, the offer is dynamic and changes based on the factors relating to the balance of the card and amount of the purchase by the consumer. For example, a balance on the credit account of $50.00 and a current purchase amount of $20.00 may yield an offer of a 20% discount off of the current purchase. Whereas, continuing with the example, a balance on the credit account of $1000.00 and a current purchase amount of $150.00 may yield an offer of a 12% discount off of the current purchase. It will be understood that the offer amount is dynamic and is subject to change based on various factors relating to the credit account and/or prospective, current, or prior purchase of the consumer.

In some embodiments, the consumer is only eligible to receive the offer or will only receive the offer upon making a payment towards the account. As such, making a payment to the credit account by the consumer may serve as a trigger for activating or initiating the offer. In some embodiments, the determination of the offer or offer amount is based at least in part on the amount of the payment made towards the balance of the credit account. For example, a credit account of the consumer may have a balance of $100.00 and when the consumer makes a payment of $20.00 to the credit account, he is offered a 5% discount offer off of a current, future, or prior purchase. Continuing with the example, when the consumer makes a payment of $100.00 and clears the entire balance of the credit account, an offer of 25% off of a current purchase is made.

In some embodiments, the system presents a plurality of options to the user for determining the offer. In such an embodiment, the system presents the plurality of options to the user, where each of the options relates to an offer with a corresponding suggested payment amount to be made by the consumer towards the balance of the credit account for receiving the offer. For example, the system may present a plurality of options to the user, via a display of the mobile device of consumer, where a first of the plurality of options may be a suggestion that the consumer pay 25% of his existing balance on the credit account for a 5% discount off of a current purchase, a second of the plurality of options may be a suggestion that the consumer pay 50% of his existing balance of the credit account for a 10% discount off of a current purchase, and a third of the plurality of options may be a suggestion that the consumer pay his entire balance on the credit account for a 20% discount off of a current purchase, and the like. It will be understood that this is only an example and the options should not be limited to the specified payment percentages and/or amounts. For example, in lieu of paying a percentage of the outstanding balance, the system may calculate or determine payment amounts that each correspond to an offer or percentage discount off of a current, future, or prior purchase made using the credit account or other form of payment. In some embodiments, upon receiving a selection of an offer from the plurality of offers by the consumer, triggers the system to automatically (without human intervention) to access a banking account or funded account of the consumer and process the payment amount associated with the selected offer. The system, in some embodiments, may access an online banking platform associated with one or more accounts of the consumer (e.g., checking, savings, other funded account, and the like), in order to process the selected payment amount.

In addition, the offer may also incentive or place as a condition for the offer that the consumer uses a self-service option for making a payment to the credit account. Self-service options may include using a mobile device to process a payment to the credit account, a computing terminal (e.g., self-service machine/terminal, personal computer, or other unmanned device, and the like). Using the self-service options the user may make a payment towards their credit account balance prior to initiating a checkout process such that the consumer would have received the offer prior to making a purchase at checkout. In that way, the consumer can utilize the offer immediately and on the current purchase.

### Providing an Offer Based on a Prepaid Account Balance and Consumer Location

Some embodiments of the present invention relate to system and methods for determining an offer based on a balance value of a credit account of a consumer and a location of the consumer.

FIG. 8 is a general process flow 800 for providing an offer to a consumer based on a balance of a prepaid account and, in some embodiments, the location of the consumer who is the holder of the prepaid account. The process flow 800 is similar to process flows 600 and 700, but in process flow 800, the system presents the offer based on the prepaid account balance and also, determines the offer amount based on any funds and/or credits added to the prepaid account. In block 802, the system receives geographic location information associated with the consumer. Then in block 804, the system receives information associated with a merchant-specific prepaid account of the consumer that is issued by the merchant and/or an affiliate of the merchant. Following in block 806, the system determines a balance value of the prepaid account based on the information received relating to the prepaid account. At block 808, the system provides an offer to the consumer based at least partially determining that the consumer is collocated with or proximate to a location of a merchant associated with the prepaid account and that the balance of the prepaid account.

Regarding block 806, the system determines the balance value of the prepaid account. In some embodiments, the system determines that the prepaid account has a diminished and/or reduced balance value indicating that the consumer who is the holder of the prepaid account has used a portion or all of a previous money or credit balance of the prepaid account. For example, a consumer may have an ABC prepaid card useable for purchases at ABC merchant, which had a starting balance value of $500.00. In this example, the consumer may have used the ABC prepaid card for a $100.00 purchase causing the balance value of the ABC prepaid account to diminish to $400.00. In such an example, the diminished balance value of the card is a value amount that is less than a first or initial balance value of the prepaid card but is greater than zero or, in some embodiments, the diminished value can be zero or less than zero. In some embodiments, the system may determine that the prepaid account of the consumer has a diminished value in any manner including, but not limited to, receiving information associated with the prepaid account via a merchant or third party financial system, via input by the user, via a transaction machine prior to, during, or immediately following a transaction involving the prepaid card.

Regarding block 808, the system presents an offer to the consumer. In some embodiments, when the system determines that the geographic location of the mobile device of the consumer is proximate to and/or coincident with a location of a merchant and further determines that the prepaid account associated with the merchant has a diminished and/or zero balance, the system provides an offer to the consumer. In many embodiments, the offer is only triggered when all elements are met: 1) the consumer is a holder of a prepaid account issued by and/or specifically designated for use at one or a specified merchant, 2) the consumer or a mobile device associated with the consumer is in close proximity or at the location of the merchant, and 3) the prepaid account has a diminished balance value or a balance value that is zero or a balance value that is less than zero. Each of these elements must exist or be met contemporaneously, in most embodiments of this invention, in order for the system to provide the offer to the consumer. The offer may be triggered to the consumer automatically (without human intervention) and in real-time or substantially real-time, as the consumer is arriving or is still proximate to or coincident with the location of the merchant and/or once the elements are met. The offer may be presented to the consumer in several manners, which may include, but is not limited to, upon making the determinations, presenting the offer via the mobile device of the consumer or presenting the offer to the consumer at the point of sale or point of transaction. For example, while the consumer is shopping within a store of the merchant the system determines that the consumer has a merchant-specific prepaid account issued by the merchant and that the prepaid account has a zero balance value. In such an example, while the consumer is shopping or preparing to checkout, the system may provide a communication to the mobile device of the consumer indicating that he has received or is eligible to receive an offer based on adding funds or credit to the prepaid account. In one example, when the consumer is preparing to checkout or is in the checkout process, the system may determine that the consumer has a prepaid card with a diminished balance value and cause or prompt the point of sale device (e.g., the cashier's register, self-checkout, or personnel managing the register) to notify the consumer of the offer. In yet another example, the system may determine that the user in the store of the merchant and that the prepaid card issued by the merchant has a diminished or zero balance value, once the consumer swipes or presents the prepaid account for making a purchase. In such an example, the system provides an offer to the consumer after the consumer presents the prepaid account for purchase. The system may queue the purchase transaction of the consumer pending acceptance or decline of the offer by the consumer. The offer may also be presented to the consumer sometime after or immediately after a purchase is at the merchant associated with the prepaid account such that the consumer may still receive the benefits of the offer for the goods or services purchased that day. In another example, the system may present the offer to the consumer when the consumer is proximate to the location of the merchant but has not yet entered the merchant location. In this way, the offer may act as an incentive for the user to visit or enter the location of the merchant, add additional funds or credit to the balance of the prepaid account, and also potentially make a purchase at the location of the merchant.

Still in other embodiments, the offer to the consumer may be determined statically or dynamically and based on at least one of a balance value of the prepaid account, a purchase amount using the prepaid account, additional funds or credits amount added to the prepaid account, any combination of the previously mentioned, and/or the like. The offer to the consumer, in some embodiments, is an offer with some benefit, where the benefit of the offer is triggered once the consumer adds funds and/or credits to the prepaid account. For example, in some embodiments, the system provides a static or predetermined offer to the consumer of a 10% discount off of a current, prior, or later purchase when the consumer deposits additional funds to the prepaid account that causes the prepaid account to reach its maximum value. In this example, the prepaid account can only have a maximum value of $500.00, an existing balance value of $10.00, and once the consumer deposits into the prepaid account $490.00 the prepaid account reaches its maximum value. In a similar example, the system may provide an offer to the consumer of a 5% discount off of a current, prior, or future purchase when the consumer adds sufficient funds or credits to the prepaid account such that the available balance value of the prepaid account is, at least, half of the maximum value of the prepaid account.

In some embodiments, the offer benefit or amount may be any amount that is dynamically determined based on the amount of funds or credits added to the prepaid account or that is predetermined based on the features and/or funds added to the prepaid account. It will be understood that the offer benefit may be determined in any manner and is not limited to the manners described herein. In some embodiments, the system determines an offer based on the features of the prepaid account. One or more features relating to the prepaid account may include the maximum value of the prepaid, purchases that can be made with the prepaid account, where the prepaid account may be used by the consumer, the ability to allow the consumer to exceed the available funds or credit on the prepaid account, and the like. In some embodiments, the system determines an offer based on the balance of the prepaid account of the consumer. Using a tiered balance system, the system may determine certain offers that range in the benefits provided to the consumer. For example, the smaller existing balance value of the prepaid account, the larger the offered incentive may be to the consumer. Using the tiered balance system, the opposite may also be true where the larger the existing balance value on the retail prepaid account, the smaller the offered incentive may be to the consumer. The tiered balance approached for determining the offer may be embodied in several different ways. In some embodiments, the tiered balance approach includes two or more levels of balance amounts, where each of the two or more relates to or corresponds to a different offer. As an example, a first tier may include balance amounts ranging from $0.01-$50.00, a second tier may include balance amounts ranging from $50.01-$500.00, and a third tier may include balance amounts ranging from $500.01-$1000 or greater. In this example, the first tier may correspond to a discount offer of 15% off of a current or future purchase, the second tier may relate to an offer for a discount of 10% off of a current purchase, and the third tier may relate to an offer for a discount of 5% off of a current purchase. The system, if applying the tiered balance approached determines the offer to present to the consumer by comparing the balance value of the prepaid account to a table or other data structure having the predetermined tiers and/or predetermined thresholds for providing a discount. Once applied, the system presents the offer, where the offer indicates that if the user makes a payment that either causes the prepaid account to reach its maximum value or brings the prepaid account balance into a tier with balance value range then the consumer will activate the offer or receive the offer. Although not previously described, no offer or an offer of 0% may be presented if there is a maximum balance value on the prepaid account.

In some embodiments, the offer amount or amount of benefit of the offer is determined based on a combination of the balance value of the prepaid account and/or a purchase amount for a past, present, or future purchase by the consumer. In such an embodiment, the offer is dynamic and changes based on the factors relating to the balance of the prepaid account and amount of the purchase by the consumer. For example, a balance value on the prepaid account of $50.00 and a current purchase amount of $20.00 may yield an offer of a 10% discount off of the current purchase when the consumer adds funds or credits to the prepaid account equaling or exceeding the current purchase amount. It will be understood that the consumer may still receive an offer although the funds or credits added do not equal the current purchase amount. It will also be understood that the offer amount is dynamic and is subject to change based on various factors relating to the prepaid account and/or prospective, current, or prior purchase of the consumer who is the holder of the prepaid account.

In some embodiments, the consumer is only eligible to receive the offer or will only receive the offer upon adding funds or credits to the prepaid account. As such, depositing funds or credits to the prepaid account by the consumer may serve as a trigger for activating or initiating the offer. In some embodiments, the determination of the offer or offer amount is based at least in part on the amount of funds or credits added towards the balance of the prepaid account. For example, a prepaid account of the consumer may have a balance of $0.00 and when the consumer adds funds of $200.00 to the prepaid account, he is offered a 5% discount offer off of a current, future, or prior purchase. Continuing with the example, when the consumer makes a payment of $500.00 and maximizes the value of the prepaid account, an offer of 25% off of a current purchase is made.

In some embodiments, the system presents a plurality of options to the user for determining the offer. In such an embodiment, the system presents the plurality of options to the consumer, where each of the options relates to an offer with a corresponding suggested payment amount to be made by the consumer towards increasing the balance value of the prepaid account for receiving the offer. For example, the system may present a plurality of options to the user, via a display of the mobile device of consumer, where a first of the plurality of options may be a suggestion that the consumer add funds of $250.00 onto the prepaid account or add funds in the amount of 25% of the maximum value of the prepaid account with a $1000 maximum value for a 5% discount off of a current purchase, a second of the plurality of options may be a suggestion that the consumer add funds of $500.00 onto the prepaid account or add funds in the amount of 50% of the maximum value of the prepaid account with a $1000 maximum value for a 10% discount off of a current purchase, and a third of the plurality of options may be a suggestion that the consumer add funds in the amount of $1000.00 onto the prepaid account or add funds in the amount of 100% of the maximum value of the prepaid account with a $1000 maximum value for a 20% discount off of a current purchase, and the like. It will be understood that this is only an example and the options should not be limited to the specified payment amounts or percentages and/or amounts. In some embodiments, upon receiving a selection of an offer from the plurality of offers by the consumer, triggers or causes the system to automatically (without human intervention) to access a banking or funded account of the consumer and process the payment amount associated with the selected offer. The system, in some embodiments, may access an online banking platform associated with one or more accounts of the consumer (e.g., checking, savings, other funded account, and the like), in order to process the selected payment amount.

In addition, the offer may also incentive or place as a condition for the offer that the consumer uses a self-service option for adding additional funds or credits to the prepaid account. Self-service options may include using a mobile device to process a deposit into the prepaid account, a computing terminal (e.g., self-service machine/terminal, personal computer, or other unmanned device, and the like). Using the self-service options the user may make a funds or credits deposit towards their prepaid account balance prior to initiating a checkout process such that the consumer would have received the offer prior to making a purchase at checkout. In that way, the consumer can utilize the offer immediately and on the current purchase.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

One or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed:

1. A system for presenting an offer based on a location of a consumer having a credit account associated with a merchant, the system comprising:
a computer processing device and a memory; and
a software module stored in the memory, comprising executable instructions that when executed by the processor causes the processor to:
receive geographic location information associated with a mobile computing device of the consumer;
receive information associated with the credit account of the consumer, wherein the consumer is a holder of the credit account;
determine whether the balance value of the credit account is greater than zero; and
present, via the mobile computing device of the consumer, the offer to the consumer based at least in part on determining that the geographic location of the mobile device of the consumer is proximate to or coincident with a location of the merchant and determining that the existing balance value of the credit account associated with the merchant is greater than zero.

2. The system of claim 1, wherein the received information associated with the credit account comprises a balance value of the credit account of the consumer.

3. The system of claim 1, the system comprising executable instructions that when executed by the processor further causes the processor to:
identify one or more merchants that are associated with the credit account of the consumer and that are within a predetermined distance of the mobile device of the consumer.

4. The system of claim 1, the system comprising executable instructions that when executed by the processor further causes the processor to:
determine the offer for the consumer based at least partially on the balance value of the credit account.

5. The system of claim 1, the system comprising executable instructions that when executed by the processor further causes the processor to:
send a notification to the identified merchant, the notification comprising information indicating that the consumer is at or near the identified merchant and further indicating that the consumer has the credit account with the existing balance value greater than zero; and
allow the identified merchant to send, in real-time or substantially real-time, the offer to the mobile device associated with the consumer and while the consumer is at or near the identified merchant.

6. The system of claim 1, wherein the credit account is issued by the merchant or in partnership with the merchant, and wherein the credit account is specifically designated for use by the consumer at locations of the merchant and/or online websites associated with the merchant.

7. The system of claim 1, the system comprising executable instructions that when executed by the processor further causes the processor to:
present, via the mobile device, a plurality of offers based at least in part on the balance of the credit account and the location of the consumer.

8. A computer-implemented method for presenting an offer based on a location of a consumer having a credit account associated with a merchant comprising:
using a computer processor to execute computer program code instructions stored in one or more non-transitory computer-readable mediums, wherein said computer program code instructions are structured to cause said computer processor to:
receive geographic location information associated with a mobile device of the consumer;
receive information associated with the credit account of the consumer, wherein the consumer is a holder of the credit account;
determine whether the balance value of the credit account is greater than zero; and
present, via the mobile device of the consumer, the offer to the consumer based at least in part on determining that the geographic location of the mobile device of the consumer is proximate to or coincident with a location of the merchant and determining that the existing balance value of the credit account associated with the merchant is greater than zero.

9. The computer-implemented method of claim 8, wherein the received information associated with the credit account comprises information relating to the balance value of the credit account of the consumer.

10. The computer-implemented method claim 8, the method further comprising:
identifying one or more merchants that are associated with the credit account of the consumer and that are within a predetermined distance of the mobile device of the consumer.

11. The computer-implemented method of claim 8, the method further comprising:
determining the offer for the consumer based at least partially on the balance value of the credit account.

12. The computer-implemented method of claim 8, the method further comprising:
sending a notification to the identified merchant, the notification comprising information indicating that the consumer is at or near the identified merchant and further indicating that the consumer has the credit account with the existing balance value greater than zero; and
allowing the identified merchant to send, in real-time or substantially real-time, the offer to the mobile device associated with the consumer and while the consumer is at or near the identified merchant.

13. The computer-implemented method of claim 8, wherein the credit account is issued by the merchant or in partnership with the merchant, and wherein the credit account is specifically designated for use by the consumer at locations of the merchant and/or online websites associated with the merchant.

14. The computer-implemented method of claim 8, the method further comprising:
present, via the mobile device, a plurality of offers based at least in part on the balance of the credit account and the location of the consumer.

15. A computer program product for presenting an offer based on a location of a consumer having a credit account associated with a merchant, the computer program product comprising a non-transitory computer-readable storage medium having computer-readable program code stored thereon, such that when the computer-readable code is executed by a computer processor it causes the computer to:
receive geographic location information associated with a mobile device of the consumer;
receive information associated with the credit account of the consumer, wherein the consumer is a holder of the credit account;
determine whether the balance value of the credit account is greater than zero; and
present, via the mobile device of the consumer, the offer to the consumer based at least in part on determining that the geographic location of the mobile device of the consumer is proximate to or coincident with a location of the merchant and determining that the existing balance value of the credit account associated with the merchant is greater than zero.

16. The computer program product of claim 15, wherein the received information associated with the credit account relates, at least, to a balance value of the credit account of the consumer.

17. The computer program product of claim 15, further comprising computer-readable code is executed by a computer processor it causes the computer to:
identify one or more merchants that are associated with the credit account of the consumer and that is within a predetermined distance of the mobile device of the consumer.

18. The computer program product of claim 15, further comprising computer-readable code is executed by a computer processor it causes the computer to:
determine the offer for the consumer based at least partially on the balance value of the credit account.

19. The computer program product of claim 15, further comprising computer-readable code is executed by a computer processor it causes the computer to:
send a notification to the identified merchant, the notification comprising information indicating that the consumer is at or near the identified merchant and further indicating that the consumer has the credit account with the existing balance value greater than zero; and
allow the identified merchant to send, in real-time or substantially real-time, the offer to the mobile device associated with the consumer and while the consumer is at or near the identified merchant.

20. The computer program product of claim 15, wherein the credit account is issued by the merchant or in partnership with the merchant, and wherein the credit account is specifically designated for use by the consumer at locations of the merchant and/or online websites associated with the merchant.
